(19) United States
(12) Patent Application Publication
(10) Pub. No.: US 2012/0075495 A1
(43) Pub. Date: Mar. 29, 2012

(54) ELECTRONIC CAMERA

(75) Inventors: Takeshi Fujiwara, Shijonawate-shi (JP); Tadayoshi Nakata, Neyagawa-shi (JP)

(73) Assignee: SANYO ELECTRIC CO., LTD., Moriguchi-shi (JP)

(21) Appl. No.: 13/242,393

(22) Filed: Sep. 23, 2011

(30) Foreign Application Priority Data
Sep. 28, 2010 (JP) 2010-217698

(51) Int. Cl. H04N 5/228

(52) U.S. Cl. 348/222.1; 348/E05.031

(57) ABSTRACT

An electronic camera includes an imager. An imager has an imaging surface capturing an optical image and outputs an electronic image corresponding to the optical image. An executor executes, along a reference criterion, a process of adjusting an imaging condition based on a partial image appeared on a designated position out of the electronic image outputted from the imager. A searcher searches for a specific object image coincident with a dictionary image from the electronic image outputted from the imager. A first selector selects a specific criterion as the reference criterion when the designated position is equivalent to a position of the specific object image discovered by the searcher. A second selector selects a criterion different from the specific criterion as the reference criterion when the designated position is different from the position of the specific object image discovered by the searcher.

### CROSS REFERENCE OF RELATED APPLICATION

The disclosure of Japanese Patent Application No. 2010-217698, which was filed on Sep. 28, 2010, is incorporated here by reference.

### BACKGROUND OF THE INVENTION

1. Field of the Invention

The present invention relates to an electronic camera. More particularly, the present invention relates to an electronic camera which adjusts an imaging condition corresponding to a touch operation.

2. Description of the Related Art

According to one example of this type of apparatus, an electronic camera is provided with a liquid crystal display portion for confirming a photographed image, a touch panel installed on the crystal display portion, a shooting lens, an imaging unit consisting of an AF module, a CCD and etc., a ranging circuit which measures a distance to a desired object of an image inputted by the imaging unit, and an autofocus driving circuit for driving the imaging unit so as to focus the desired object.

Moreover, out of objects within a photographing range displayed on the crystal display portion, an object existing at an arbitrary position in the photographing range is focused and photographed by following processes: a focus block which is a position intended to focus is designated on the touch panel, a distance to the object in the designated focus block is measured by the ranging circuit, and the autofocus driving circuit is controlled based on a measured result.

However, in the above-described apparatus, an adjustment manner of an imaging condition other than designating the focus block by the touch panel operation is not described. Therefore, it is unclear that it is possible to simultaneously use another imaging condition adjustment manner such as a face detection. Thereby, the adjustment manner of the imaging condition may be limited.

### SUMMARY OF THE INVENTION

An electronic camera according to the present invention, comprises: an imager, having an imaging surface capturing an optical image, which outputs an electronic image corresponding to the optical image; an executor which executes, along a reference criterion, a process of adjusting an imaging condition based on a partial image appeared on a designated position out of the electronic image outputted from the imager; a searcher which searches for a specific object image coincident with a dictionary image from the electronic image outputted from the imager; a first selector which selects a specific criterion as the reference criterion when the designated position is equivalent to a position of the specific object image discovered by the searcher; and a second selector which selects a criterion different from the specific criterion as the reference criterion when the designated position is different from the position of the specific object image discovered by the searcher.

According to the present invention, a computer program embodied in a tangible medium, which is executed by a processor of an electronic camera provided with an imager, having an imaging surface capturing an optical image, which outputs an electronic image corresponding to the optical image, the program comprises: an executing instruction to execute, along a reference criterion, a process of adjusting an imaging condition based on a partial image appeared on a designated position out of the electronic image outputted from the imager; a searching instruction to search for a specific object image coincident with a dictionary image from the electronic image outputted from the imager; a first selecting instruction to select a specific criterion as the reference criterion when the designated position is equivalent to a position of the specific object image discovered based on the searching instruction; and a second selecting instruction to select a criterion different from the specific criterion as the reference criterion when the designated position is different from the position of the specific object image discovered based on the searching instruction.

According to the present invention, an imaging control method executed by an electronic camera provided with an imager, having an imaging surface capturing an optical image, which outputs an electronic image corresponding to the optical image, the imaging control method comprises: an executing step of executing, along a reference criterion, a process of adjusting an imaging condition based on a partial image appeared on a designated position out of the electronic image outputted from the imager; a searching step of searching for a specific object image coincident with a dictionary image from the electronic image outputted from the imager; a first selecting step of selecting a specific criterion as the reference criterion when the designated position is equivalent to a position of the specific object image discovered by the searching step; and a second selecting step of selecting a criterion different from the specific criterion as the reference criterion when the designated position is different from the position of the specific object image discovered by the searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is a block diagram showing one example of a configuration of a face detecting circuit;

FIG. 5 is an illustrative view showing one example of a configuration of a register applied to the embodiment in FIG. 2;

FIG. 6 is an illustrative view showing one example of an electronic image displayed on a monitor screen;

FIG. 7 is a flowchart showing one portion of behavior of a CPU applied to the embodiment in FIG. 2;

FIG. 8 is a flowchart showing another portion of the behavior of the CPU applied to the embodiment in FIG. 2;

FIG. 9 is a flowchart showing still another portion of the behavior of the CPU applied to the embodiment in FIG. 2;

FIG. 10 is a flowchart showing yet another portion of the behavior of the CPU applied to the embodiment in FIG. 2; and

FIG. 11 is a block diagram showing a configuration of another embodiment of the present invention.

### DETAILED DESCRIPTION OF THE PREFERRED EMBODIMENTS

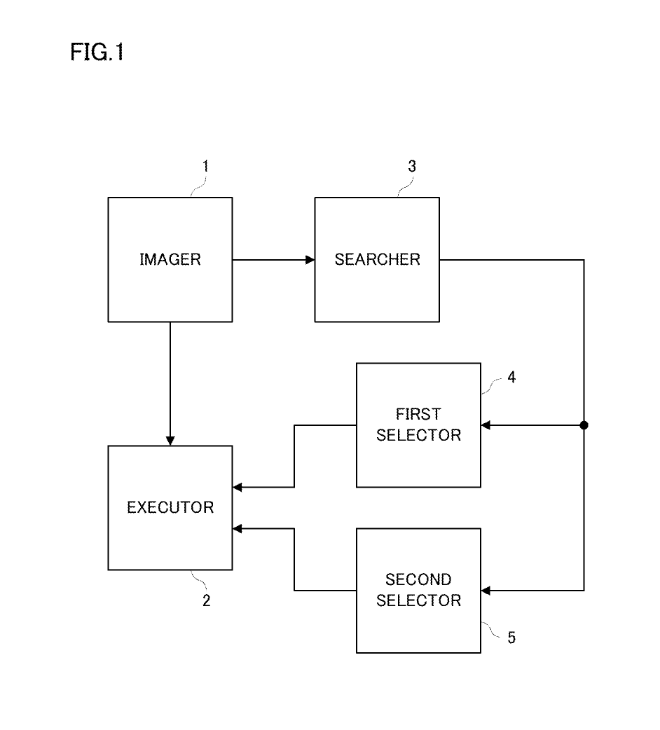

With reference to FIG. 1, an electronic camera according to one embodiment of the present invention is basically configured as follows: An imager 1 has an imaging surface capturing an optical image and outputs an electronic image corresponding to the optical image. An executor 2 executes, along a reference criterion, a process of adjusting an imaging condition based on a partial image appeared on a designated position out of the electronic image outputted from the imager 1. A searcher 3 searches for a specific object image coincident with a dictionary image from the electronic image outputted from the imager 1. A first selector 4 selects a specific criterion as the reference criterion when the designated position is equivalent to a position of the specific object image discovered by the searcher 3. A second selector 5 selects a criterion different from the specific criterion as the reference criterion when the designated position is different from the position of the specific object image discovered by the searcher 3.

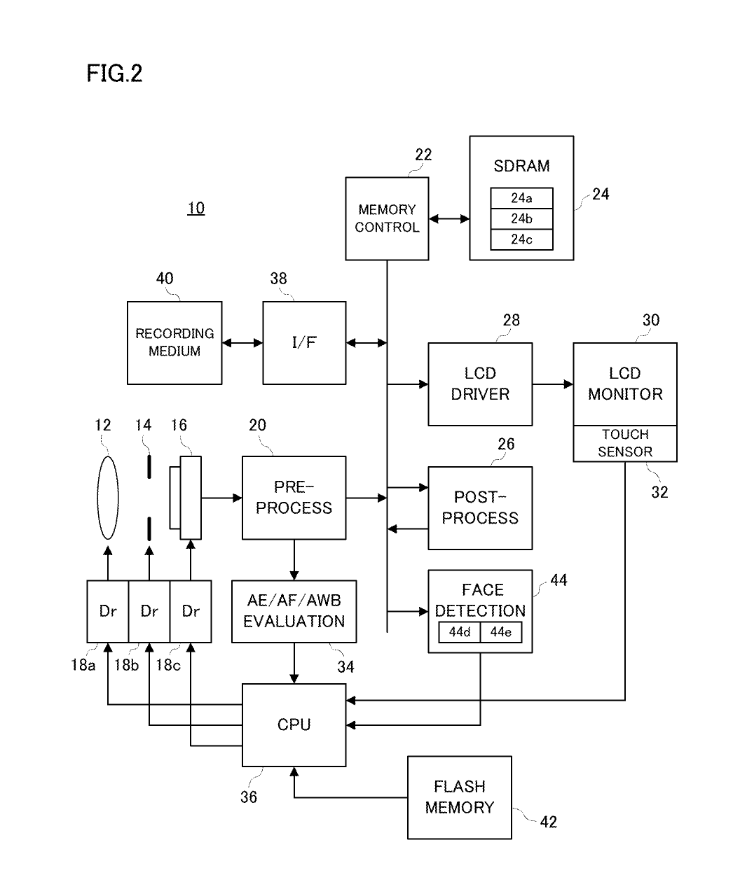

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion. Thereby, electric charges representing the electronic image are produced.

When a power source is applied, in order to execute a moving-image taking process, a CPU 36 commands a driver 18c to repeat an exposure procedure and an electric-charge reading-out procedure under the imaging task. In response to a vertical synchronization signal Vsync periodically generated from an SG (Signal Generator) not shown, the driver 18c exposes the imaging surface and reads out the electric charges produced on the imaging surface in a raster scanning manner. From the image sensor 16, raw image data that is based on the read-out electric charges is cyclically outputted.

A pre-processing circuit 20 performs processes, such as digital clamp, pixel defect correction, gain control and etc., on the raw image data outputted from the image sensor 16. The raw image data on which these processes are performed is written into a raw image area 24a of an SDRAM 24 through a memory control circuit 22.

A post-processing circuit 26 reads out the raw image data accommodated in the raw image area 24a through the memory control circuit 22, and performs processes such as a color separation process, a white balance adjusting process, a YUV converting process, on the read-out raw image data. Moreover, the post-processing circuit 26 executes a zoom process for display on image data that comply with a YUV format. As a result, display image data that comply with the YUV format is individually created. The display image data is written into a display image area 24b of the SDRAM 24 by the memory control circuit 22.

An LCD driver 28 repeatedly reads out the display image data accommodated in the display image area 24b through the memory control circuit 22, and drives an LCD monitor 30 based on the read-out image data. As a result, a real-time moving image (a live view image) of the scene is displayed on a monitor screen.

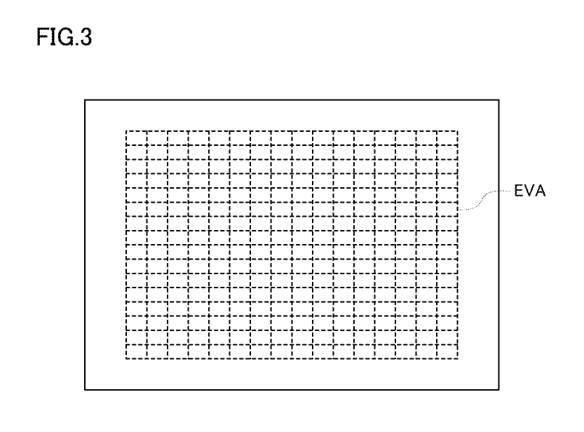

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 simply converts the raw image data into Y data and RGB data.

An AE/AF/AWB evaluating circuit 34 integrates Y data belonging to the evaluation area EVA for each divided area, out of the Y data produced by the pre-processing circuit 20, at every time the vertical synchronization signal Vsync is generated. Thereby, 256 integral values (256 AE evaluation values) are outputted from the AE/AF/AWB evaluating circuit 34 in response to the vertical synchronization signal Vsync.

Moreover, the AE/AF/AWB evaluating circuit 34 extracts a high-frequency component of the Y data belonging to the same evaluation area EVA, out of the Y data outputted from the pre-processing circuit 20, at every time the vertical synchronization signal Vsync is generated so as to integrate the extracted high-frequency component for each divided area. Thereby, 256 integral values (256 AF evaluation values) are outputted from the AE/AF/AWB evaluating circuit 34 in response to the vertical synchronization signal Vsync.

Moreover, the AE/AF/AWB evaluating circuit 34 integrates RGB data belonging to the same evaluation area EVA for each divided area, out of the RGB data outputted from the pre-processing circuit 20, at every time the vertical synchronization signal Vsync is generated. Thereby, 256 integral values (256 AWB evaluation values) are outputted from the AE/AF/AWB evaluating circuit 34 in response to the vertical synchronization signal Vsync.

When a touch operation is not performed on the monitor screen, under the imaging task, the CPU 36 executes a simple AE process based on output from the AE/AF/AWB evaluating circuit 34 so as to calculate an appropriate EV value. An aperture amount and an exposure time period that define the calculated appropriate EV value are respectively set to the drivers 18b and 18c. As a result, a brightness of the live view image is adjusted approximately.

In parallel with the moving-image taking process, under a face detecting task, the CPU 36 repeatedly issues a searching request toward a face detecting circuit 44.

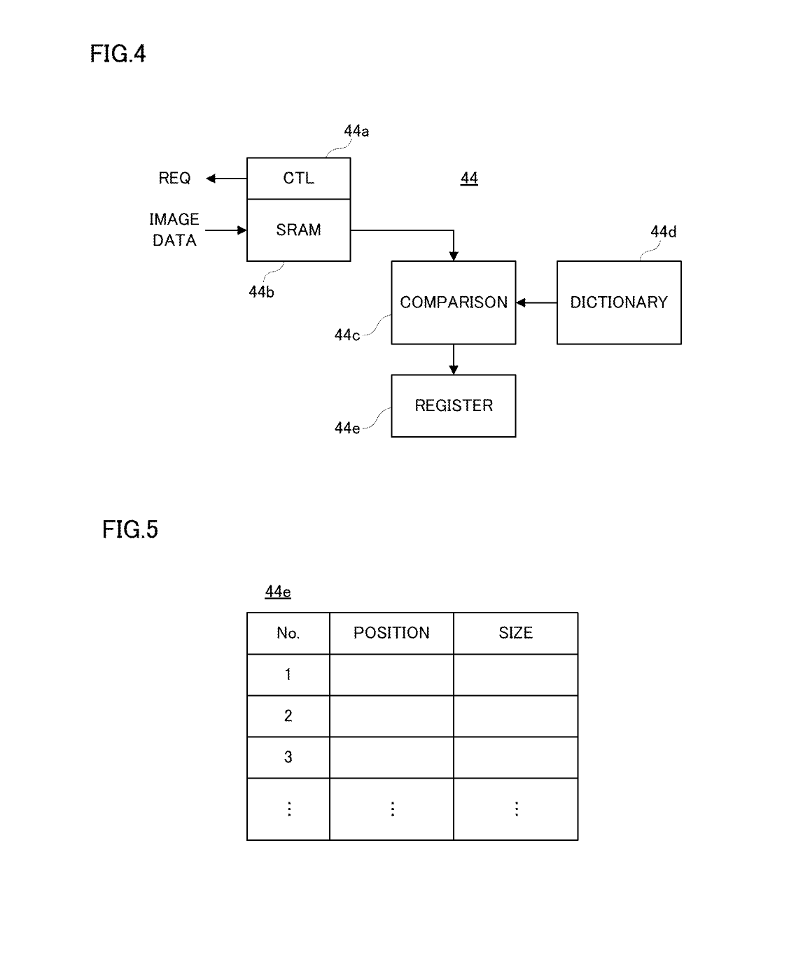

The face detecting circuit 44 is configured as shown in FIG. 4. The face detecting circuit 44 moves a comparing frame structure in a raster scanning manner from a head position of the display image accommodated in the display image area 24b toward a tail end position thereof so as to compare a partial image belonging to the comparing frame structure with a face image registered in a dictionary 44d.

When the image in the comparing frame structure coincides with the registered face image, the face detecting circuit 44 registers a size and a position of the comparing frame structure at a current time point on a register 44e as shown in FIG. 5. The comparing frame structure is reduced at every time reaching the tail end position, and is set again to the head position thereafter. Thereby, comparing frame structures having mutually different sizes are scanned on the electronic image in a raster direction. When a comparing frame structure of a minimum size reaches the tail end position, a searching end notification is sent back from the face detecting circuit 44 toward the CPU 36.

In response to the searching end notification sent back from the face detecting circuit 44, the CPU 36 determines whether or not searching for a face of a person is successful. When at least one comparing frame structure is registered in the register 44e, it is determined that searching for the face image is successful. In contrary, when the comparing frame structure is not registered in the register 44e, it is determined that searching for the face image is unsuccessful.

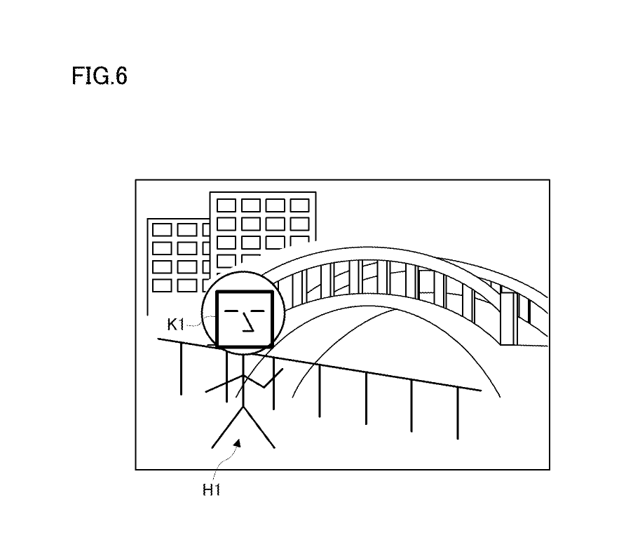

When searching for the face image is successful, the CPU 36 detects comparing frame structure information registered in the register 44e so as to issue a face-frame-structure character display command corresponding to the detected comparing frame structure information toward the LCD driver 28. The LCD driver 28 drives the LCD monitor 30 with reference to thus applied face-frame-structure character display command. A face-frame-structure character is displayed on the LCD monitor 30 in a manner to surround a face of a person appeared in the live view image. Thus, when the scene shown in FIG. 6 is captured, a face-frame-structure character K1 is displayed at a position surrounding a face of a person H1.

When searching for the face image is unsuccessful, the CPU 36 issues a face-frame-structure character non-display command toward the LCD driver 28. As a result, the face-frame-structure character displayed on the LCD monitor 30 is disappeared.

When the touch operation is performed on the monitor screen in a state where the live view image is displayed on the LCD monitor 30, a touch position is detected by a touch sensor 32, and therefore, a detected result is applied to the CPU 36.

Subsequently, under the imaging task, the CPU 36 determines whether or not the touch position is inside of any one of one or at least two comparing frame structures registered in the register 44e. When the touch position is inside of any one of the comparing frame structures, the CPU 36 determines that the person is designated by the touch operation so as to set an adjustment criterion of the imaging condition for a portrait scene.

When the touch position is not inside of any of the comparing frame structures, the CPU 36 determines that the person is not designated by the touch operation, and then, determines that the scene is equivalent to which one of a plurality of photographed scenes except the portrait scene, i.e., a night-view scene and a landscape scene. Each of the night-view scene determination and the landscape scene determination is executed based on the AE evaluation values, the AF evaluation values and the AWB evaluation values outputted from the AE/AF/AWB evaluating circuit 34.

As a result of the determination, when the scene is equivalent to the night-view scene, the CPU 36 sets the adjustment criterion of the imaging condition for the night-view scene. When the scene is equivalent to the landscape scene, the CPU 36 sets the adjustment criterion of the imaging condition for the landscape scene. When the scene is not equivalent to any of the night-view scene and the landscape scene, the CPU 36 sets the adjustment criterion of the imaging condition for a default scene.

Subsequently, the CPU 36 extracts AE evaluation values, AF evaluation values and AWB evaluation values corresponding to the touch position, from among the 256 AE evaluation values, the 256 AF evaluation values and the 256 AWB evaluation values outputted from the AE/AF/AWB evaluating circuit 34.

The CPU 36 executes a strict AE process that is based on the extracted partial AE evaluation values along the set adjustment criterion. An aperture amount and an exposure time period that define an optimal EV value calculated by the strict AE process are respectively set to the drivers 18b and 18c. As a result, the brightness of the live view image is adjusted to a brightness in which a part of the scene equivalent to the touch position is noticed.

Upon completion of the strict AE process, the CPU 36 executes an AF process that is based on the extracted partial AF evaluation values along the set adjustment criterion. As a result, the focus lens 12 is placed at a focal point in which a part of the scene equivalent to the touch position is noticed, and thereby, a sharpness of the live view image is improved.

Upon completion of the AF process, the CPU 36 executes an AWB process that is based on the extracted partial AWB evaluation values along the set adjustment criterion. Thereby, an appropriate white balance adjustment gain is calculated. The calculated appropriate white balance adjustment gain is set to the post-processing circuit 26, and as a result, the white balance of the live view image is adjusted to a white balance in which a part of the scene equivalent to the touch position is noticed.

In a case where the adjustment criterion of the imaging condition is set for the portrait scene, after the AWB process is completed, the CPU 36 executes portrait adjusting processes such as a skin color emphasizing process and a noise removal process. As a result, a sharpness of an image representing a skin color portion of the person is improved.

When the imaging condition is thus adjusted, a still-image taking process and a recording process are executed. One frame of the display image data at a time point at which the touch operation is performed on the monitor screen is taken into a still-image area 24c by the still-image taking process. The taken one flame of the image data is read out from the still-image area 24c by an I/F 38 which is started up in association with the recording process, and is recorded on a recording medium 40 in a file format.

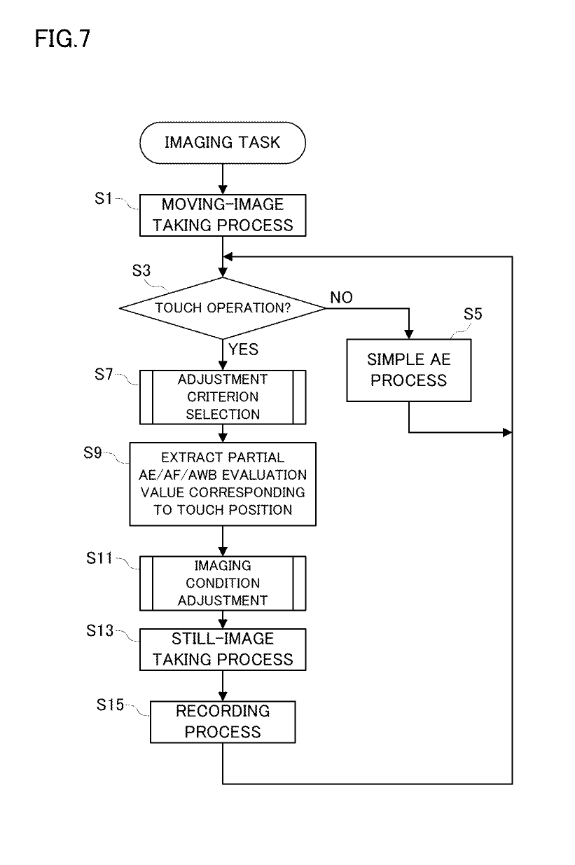

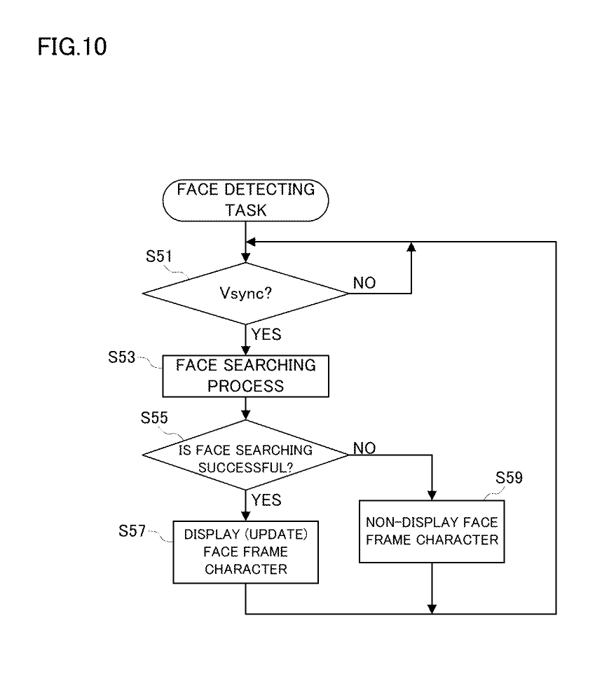

The CPU 36 executes a plurality of tasks including the imaging task shown in FIG. 7 and the face detecting task shown in FIG. 10, in a parallel manner. It is noted that, control programs corresponding to these tasks are stored in a flash memory 42.

With reference to FIG. 7, in a step S1, the moving-image taking process is executed. As a result, the live view image representing the scene is displayed on the LCD monitor 30. In a step S3, it is determined whether or not the touch operation is performed, and when a determined result is NO, the simple AE process is executed in a step S5, and thereafter, the process returns to the step S3. The brightness of the live view image is adjusted approximately by the simple AE process.

When the determined result of the step S3 is updated from NO to YES, in a step S7, an adjustment criterion selecting process is executed. As a result, a photographed scene is determined in a manner which is different depending on the touch position so as to select an adjustment criterion corresponding to a determined photographed scene as the adjustment criterion of the imaging condition.

In step S9, out of the 256 AE evaluation values, the 256 AF evaluation values and the 256 AWB evaluation values outputted from the AF/AF/AWB evaluating circuit 34, the AE evaluation values, the AF evaluation values and the AWB evaluation values corresponding to the touch position are extracted. In a step S11, an imaging condition adjusting process is executed based on thus extracted partial AE evaluation values, AF evaluation values and AWB values. As a result, the imaging condition is adjusted by noticing a partial scene equivalent to the touch position.

In a step S13, the still-image taking process is executed. As a result, one frame of the display image data at the time point at which the touch operation is performed on the monitor screen is taken into the still-image area 24c. In a step S15, the recording process is executed. As a result, the one frame of the image data taken into the still-image area 24c is read out so as to record on the recording medium 40 in the file format.

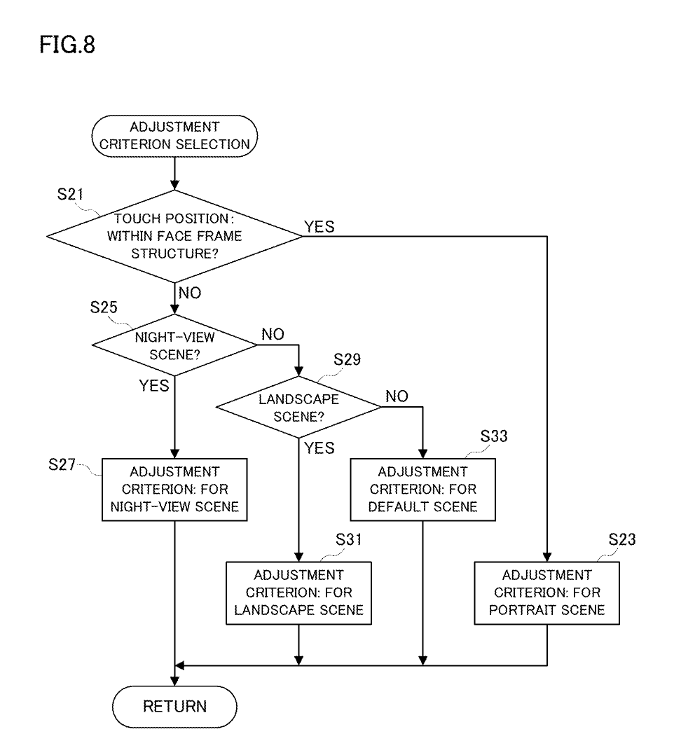

The adjustment criterion selecting process in the step S7 is executed according to a subroutine shown in FIG. 8. In a step S21, it is determined whether or not the touch position is inside of any one of one or at least two comparing frame structures registered in the register 44e. When a determined result is YES, it is determined that the person is designated by the touch operation, and in a step S23, the adjustment criterion of the imaging condition is set for the portrait scene.

When the determined result is NO, in a step S25, it is determined whether or not the scene is equivalent to the night-view scene, and in a step S29, it is determined whether or not the scene is equivalent to the landscape scene. When YES is determined in the step S25, in a step S27, the adjustment criterion of the imaging condition is set for the night-view scene. When YES is determined in the step S29, in a step S31, the adjustment criterion of the imaging condition is set for the landscape scene. When NO is determined in both of the steps S25 and S29, in a step S33, the adjustment criterion of the imaging condition is set for a default scene. Upon completion of the processes in the steps S23, S27, S31 or S33, the process returns to the routine in an upper hierarchy.

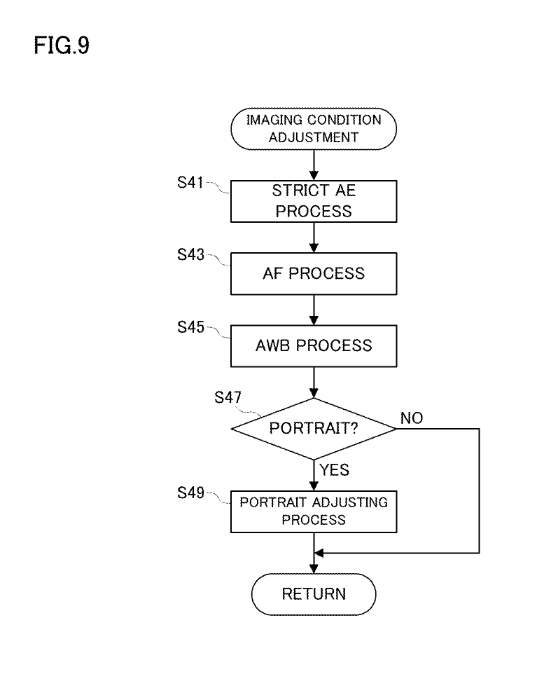

The imaging condition adjusting process in the step S11 is executed according to a subroutine shown in FIG. 9. In a step S41, the strict AE process that is based on the partial AE evaluation values extracted in the step S9 is executed along the adjustment criterion set in the step S7. The aperture amount and the exposure time period that define the optimal EV value calculated by the strict AE process are respectively set to the drivers 18b and 18c. As a result, the brightness of the live view image is adjusted to the brightness in which a partial scene equivalent to the touch position is noticed.

In a step S43, the AF process that is based on the partial AF evaluation values extracted in the step S9 is executed along the adjustment criterion set in the step S7. As a result, the focus lens 12 is placed at the focal point in which the partial scene equivalent to the touch position is noticed, and thereby, the sharpness of the live view image is improved.

In a step S45, the AWB process that is based on the partial AWB evaluation values extracted in the step S9 is executed along the adjustment criterion set in the step S7. Thereby, the appropriate white balance adjustment gain is calculated. The calculated appropriate white balance adjustment gain is set to the post-processing circuit 26, and as a result, the white balance of the live view image is adjusted to the white balance in which the partial scene equivalent to the touch position is noticed.

In a step S47, it is determined whether or not the adjustment criterion of the imaging condition is set for the portrait scene. When a determined result is NO, the process returns to the routine in an upper hierarchy while when the determined result is YES, the process returns to the routine in an upper hierarchy via a process in a step S49.

In the step S49, the portrait adjusting processes such as the skin color emphasizing process and the noise removal process are executed. As a result, the sharpness of the image representing the skin color portion of the person is improved.

With reference to FIG. 10, in a step S51, it is determined whether or not the vertical synchronization signal Vsync is generated. When a determined result is updated from NO to YES, the searching request for a face searching process is issued toward the face detecting circuit 44. As a result, the face searching process is executed in the face detecting circuit 44 so as to register the position and size of the comparing frame structure which covers the detected face image on the register 44e.

When the searching end notification is sent back from the face detecting circuit 44, in a step S55, it is determined whether or not searching for the face image is successful. When at least one comparing frame structure is registered in the register 44e, it is determined that searching for the face image is successful, and the process advances to a step S57. Thereafter, the process returns to the step S51. In contrary when the comparing frame structure is not registered in the register 44e, it is determined that searching for the face image is unsuccessful, and the process advances to a step S59. Thereafter, the process returns to the step S51.

In the step S57, the face-frame-structure character display command is issued toward the LCD driver 28. The LCD driver 28 drives the LCD monitor 30 with reference to thus applied face-frame-structure character display command. The face-frame-structure character is displayed on the LCD monitor 30 in a manner to surround the face of the person appeared in the live view image. In the step S59, the face-frame-structure character non-display command is issued toward the LCD driver 28. As a result, the face-frame-structure character displayed on the LCD monitor 30 is disappeared.

As can be seen from the above-described explanation, the image sensor 16 has the imaging surface capturing the scene and outputs the electronic image, and the CPU 36 executes, along the reference criterion, the process of adjusting the imaging condition based on the partial image appeared on the designated position out of the electronic image outputted from the image sensor 16. The CPU 36 and the face detecting circuit 44 search for the specific object image coincident with the dictionary image from the electronic image outputted from the image sensor 16. Moreover, the CPU 36 determines whether or not the designated position is equivalent to the position of the specific object image discovered by the CPU 36 and the face detecting circuit 44. The CPU 36 selects the specific criterion as the reference criterion when a determined result is positive while selects the criterion different from the specific criterion as the reference criterion when the determined result is negative.

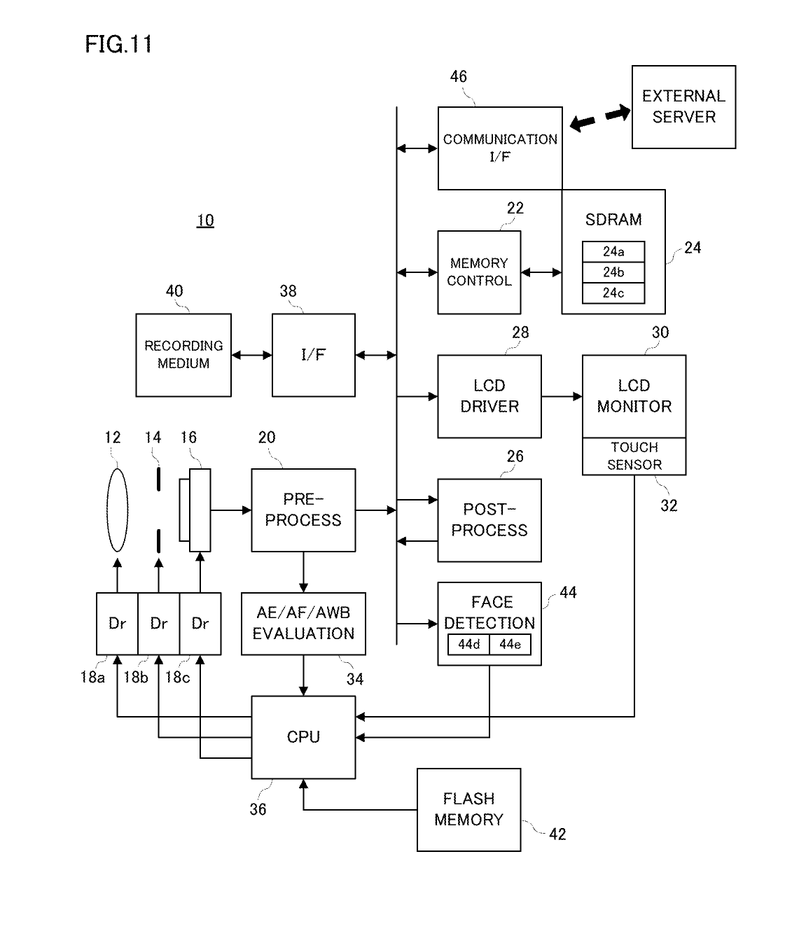

It is noted that, in this embodiment, control programs equivalent to the multi task operating system and the plurality of tasks executed thereby are previously stored in the flash memory 42. However, a communication I/F 46 for connecting to an external server may be arranged in the digital camera 10 as shown in FIG. 11 so as to initially prepare a part of the control programs in the flash memory 42 as an internal control program while acquire another part of the control programs from the external server as an external control program. In this case, the above-described procedures are realized in cooperation with the internal control program and the external control program.

Moreover, in this embodiment, the processes executed by the CPU 36 are divided into the imaging task shown in FIG. 7 and the face detecting task shown in FIG. 10. However, these tasks may be further divided into a plurality of small tasks, and furthermore, a part of the divided plurality of small tasks may be integrated into the main task. Moreover, when a transferring task is divided into the plurality of small tasks, the whole task or a part of the task may be acquired from the external server.

Moreover, in this embodiment, it is determined that the scene is equivalent to which of the portrait scene, the night-view scene, the landscape scene or the default scene. However, it may be determined that the scene is equivalent to a photographed scene other than these scenes.

Moreover, in this embodiment, it is determined whether or not the touch position is inside of the comparing frame structure by searching for the face image of the person. However, it may be determined whether or not the touch position is inside of the comparing frame structure by searching for an image other than the face image of the person.

Moreover, in this embodiment, the present invention is explained by using a digital still camera, however, a digital video camera, cell phone units and a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing an optical image, which outputs an electronic image corresponding to the optical image;
an executor which executes, along a reference criterion, a process of adjusting an imaging condition based on a partial image appeared on a designated position out of the electronic image outputted from said imager;
a searcher which searches for a specific object image coincident with a dictionary image from the electronic image outputted from said imager;
a first selector which selects a specific criterion as the reference criterion when the designated position is equivalent to a position of the specific object image discovered by said searcher; and
a second selector which selects a criterion different from the specific criterion as the reference criterion when the designated position is different from the position of the specific object image discovered by said searcher.

2. An electronic camera according to claim 1, wherein said second selector includes a scene determiner which determines a scene represented by the electronic image outputted from said imager, and a criterion selector which selects a criterion being different depending upon a determined result of said scene determiner.

3. An electronic camera according to claim 1, wherein said executor includes an extractor which extracts a parameter value defining a quality of the partial image appeared on the designated position, and an adjustment executor which adjusts the imaging condition based on the parameter value extracted by said extractor.

4. An electronic camera according to claim 1, wherein said imager and said searcher repeatedly execute in parallel an imaging process and a searching process, respectively.

5. An electronic camera according to claim 1, further comprising:
a reproducer which reproduces the electronic image outputted from said imager on a monitor screen; and
an acceptor which accepts a position designating operation in parallel with a reproducing process of said reproducer on the monitor screen, wherein the designated position is equivalent to a position designated by the position designating operation.

6. An electronic camera according to claim 1, wherein the specific Object image is equivalent to a face image of a person, and the specific criterion corresponds to a portrait mode.

7. A computer program embodied in a tangible medium, which is executed by a processor of an electronic camera provided with an imager, having an imaging surface capturing an optical image, which outputs an electronic image corresponding to the optical image, said program comprising:
an executing instruction to execute, along a reference criterion, a process of adjusting an imaging condition based on a partial image appeared on a designated position out of the electronic image outputted from said imager;
a searching instruction to search for a specific object image coincident with a dictionary image from the electronic image outputted from said imager;
a first selecting instruction to select a specific criterion as the reference criterion when the designated position is equivalent to a position of the specific object image discovered based on said searching instruction; and
a second selecting instruction to select a criterion different from the specific criterion as the reference criterion when the designated position is different from the position of the specific object image discovered based on said searching instruction.

8. An imaging control method executed by an electronic camera provided with an imager, having an imaging surface capturing an optical image, which outputs an electronic image corresponding to the optical image, said imaging control method, comprising:
an executing step of executing, along a reference criterion, a process of adjusting an imaging condition based on a partial image appeared on a designated position out of the electronic image outputted from said imager;
a searching step of searching for a specific object image coincident with a dictionary image from the electronic image outputted from said imager;
a first selecting step of selecting a specific criterion as the reference criterion when the designated position is equivalent to a position of the specific object image discovered by said searching step; and
a second selecting step of selecting a criterion different from the specific criterion as the reference criterion when the designated position is different from the position of the specific object image discovered by said searching step.
